(19) United States
(12) Patent Application Publication
(10) Pub. No.: US 2026/0142681 A1
(43) Pub. Date: May 21, 2026

(54) COMMUNICATION SYSTEM AND COMMUNICATION DEVICE

(71) Applicant: MediaTek Singapore Pte. Ltd., Singapore (SG)

(72) Inventors: Feng YANG, Shanghai (CN); Wenwei QIANG, Shanghai (CN)

(21) Appl. No.: 19/316,415

(22) Filed: Sep. 2, 2025

(30) Foreign Application Priority Data
Nov. 20, 2024 (CN) 202411666480.5

(51) Int. Cl. H04B 1/04

(52) U.S. Cl. CPC H04B 1/04

(57) ABSTRACT

A communication system includes a network device and a communication device. The communication device can communicate with the network device. The communication device includes a transmitter module and a control circuit. The control circuit can control the transmitter module to selectively transmit an RF (Radio Frequency) signal to the network device.

### CROSS REFERENCE TO RELATED APPLICATIONS

This application claims priority of China patent application No. 202411666480.5 filed on Nov. 20, 2024, the entirety of which is incorporated by reference herein.

### TECHNICAL FIELD

The disclosure generally relates to a communication system, and more particularly, it relates to a communication system for reducing the SAR (Specific Absorption Rate).

### BACKBGOUND

With the advancements being made in mobile communication technology, mobile devices such as portable computers, mobile phones, multimedia players, and other hybrid functional portable electronic devices have become more common. To satisfy users' demands, mobile devices can usually perform wireless communication functions. Some devices cover a large wireless communication area; these include mobile phones using 2G, 3G, LTE (Long Term Evolution) and 5G systems and using frequency bands of 700 MHz, 850 MHz, 900 MHz, 1800 MHz, 1900 MHz, 2100 MHz, 2300 MHz, and 2500 MHz.

SAR (Specific Absorption Rate) is an RF dosimetry that quantifies the amount and distribution of electromagnetic energy absorbed by biological objects exposed to RF fields. Overexposure to RF energy can damage human tissues. To avoid it, many countries around the world have introduced standards that limit the amount of RF radiation allowed for all types of transmitters. It should be noted that SAR may be too high to comply with regulations and laws. Accordingly, there is a need to propose a novel solution for solving the problems of the prior art.

### BRIEF SUMMARY

In an exemplary embodiment, the invention is directed to a communication system that includes a network device and a communication device. The communication device can communicate with the network device. The communication device includes a transmitter module and a control circuit. The control circuit can control the transmitter module to selectively transmit an RF (Radio Frequency) signal to the network device.

In some embodiments, the transmitter module transmits the RF signal to the network device during a plurality of first time periods.

In some embodiments, the transmitter module stops transmitting the RF signal to the network device during a plurality of second time periods.

In some embodiments, the second time periods are interleaved with the first time periods.

In some embodiments, the power of the RF signal is set to 0 during the second time periods.

In some embodiments, the control circuit controls the transmitter module according to the power of the RF signal.

In some embodiments, the control circuit calculates a timing average of the power of the RF signal, and compares the timing average with a first threshold and a second threshold.

In some embodiments, the second threshold is higher than the first threshold.

In some embodiments, if the timing average reaches the second threshold, the control circuit will control the transmitter module to stop performing an uplink transmission.

In some embodiments, if the timing average reaches the first threshold, the control circuit will control the transmitter module to resume performing the uplink transmission.

In some embodiments, the network device includes a base station.

In some embodiments, the network device includes a satellite.

In some embodiments, the communication device is a mobile phone.

In another exemplary embodiment, the invention is directed to a communication device for communicating with a network device. The communication device includes a transmitter module and a control circuit. The control circuit can control the transmitter module to selectively transmit an RF signal to the network device.

In another exemplary embodiment, the invention is directed to a communication method that includes the steps of: communicating with a network device by a communication device; and selectively transmitting an RF signal to the network device by the communication device.

### BRIEF DESCRIPTION OF THE DRAWINGS

The present disclosure can be more fully understood by reading the subsequent detailed description and examples with references made to the accompanying drawings, wherein:

FIG. 1 is a diagram of a communication system according to an embodiment of the invention;

FIG. 2 is a diagram of a waveform of an RF signal according to an embodiment of the invention;

FIG. 3 is a diagram of a communication system according to an embodiment of the invention;

FIG. 4 is a diagram of a waveform of a timing average of power of an RF signal according to an embodiment of the invention;

FIG. 5 is a diagram of signal transmission between a network device and a communication device according to an embodiment of the invention; and

FIG. 6 is a flowchart of a communication method according to an embodiment of the invention.

### DETAILED DESCRIPTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to...”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

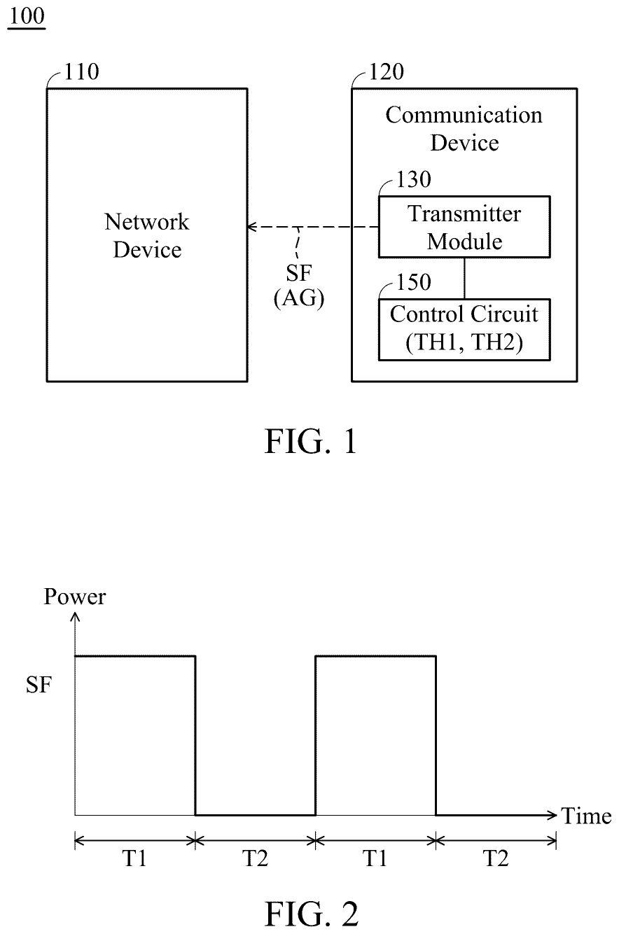

FIG. 1 is a diagram of a communication system 100 according to an embodiment of the invention. As shown in FIG. 1, the communication system 100 includes a network device 110 and a communication device 120. The communication device 120 can communicate with the network device 110. For example, the network device 110 may be an external device (such as a base station), and the communication device 120 may be a user equipment (such as a mobile phone, a tablet computer, or a notebook computer), but they are not limited thereto.

Specifically, the communication device 120 includes a transmitter module 130 and a control circuit 150. The transmitter module 130 is coupled to the control circuit 150. For example, the transmitter module 130 may include an antenna element and a signal source (not shown), and the signal source may use the antenna element for signal transmission. The control circuit 150 may be implemented with a processor or an MCU (Microcontroller Unit). The control circuit 150 can control the transmitter module 130 to selectively transmit an RF (Radio Frequency) signal SF to the network device 110. It should be understood that the communication device 120 may further include other components, such as a battery, a housing, or a touch panel, although they are not displayed in FIG. 1.

FIG. 2 is a diagram of the waveform of the RF signal SF according to an embodiment of the invention. The horizontal axis represents the time, and the vertical axis represents the (instantaneous) power of the RF signal SF. Please refer to FIG. 1 and FIG. 2 together to understand the invention. The transmitter module 130 can transmit the RF signal SF to the network device 110 during a plurality of first time periods T1. In addition, the transmitter module 130 can stop transmitting the RF signal SF to the network device 110 during a plurality of second time periods T2. It should be noted that the power of the RF signal SF can be set to 0 during the second time periods T2. That is, the communication device 120 can alternately enable and disable the transmission of the RF signal SF. For example, the transmission of the RF signal SF may be enabled by the control circuit 150 according to a notification from the network device 110, but it is not limited thereto. The first time periods T1 and the second time periods T2 may be arranged by the control circuit 150. In some embodiments, the second time periods T2 are interleaved with the first time periods T1. For example, each second time period T2 may be equal to one of the first time periods T1. However, the invention is not limited thereto. Alternatively, each second time period T2 may be longer or shorter than one of the first time periods T1.

With such a design, the communication device 120 can sometimes completely disable the uplink transmission to the network device 110 (e.g., during the second time periods T2). Thus, the average power of the RF signal SF can be significantly reduced. According to practical measurements, the proposed design of the invention not only reduce the RF exposure and the power consumption of the communication system 100 but also improves the SAR (Specific Absorption Rate) relative to the communication device 120.

The following embodiments will introduce different configurations and detail structural features of the communication system 100. It should be understood that these figures and descriptions are merely exemplary, rather than limitations of the invention. In alternative embodiments, the communication device 120 can be used independently.

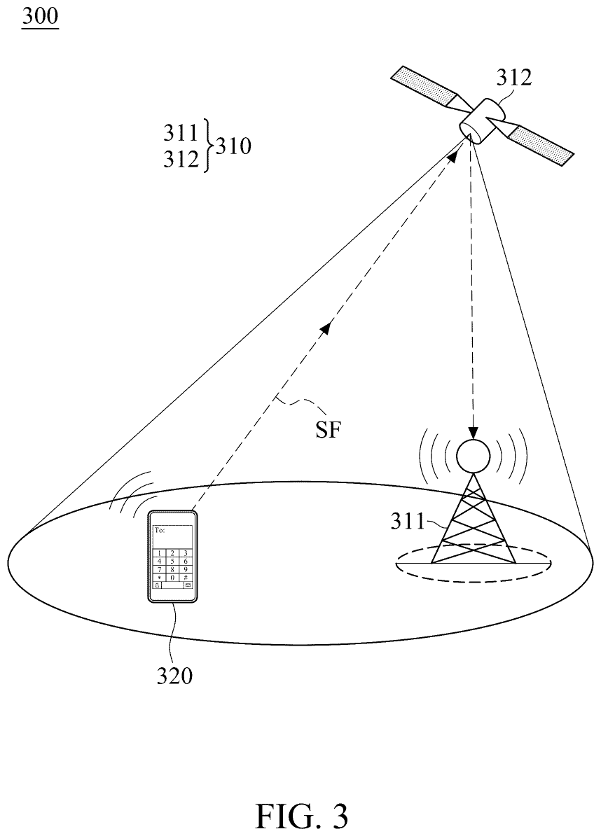

FIG. 3 is a diagram of a communication system 300 according to an embodiment of the invention. In the embodiment of FIG. 3, the communication system 300 includes a network device 310 and a communication device 320. Specifically, the network device 310 includes a base station 311 and a satellite 312, and the communication device 320 is a mobile phone. For example, the communication device 320 may transmit an RF signal SF to the satellite 312, and then the satellite 312 may relay the RF signal SF to the base station 311. It should be noted that the satellite 312 is configured to cover a larger communication area and to support the NTN (Non-Terrestrial Network) communication. In alternative embodiments, the network device 310 merely includes either the base station 311 or the satellite 312. In other embodiments, the communication system 300 includes more network devices and more communication devices.

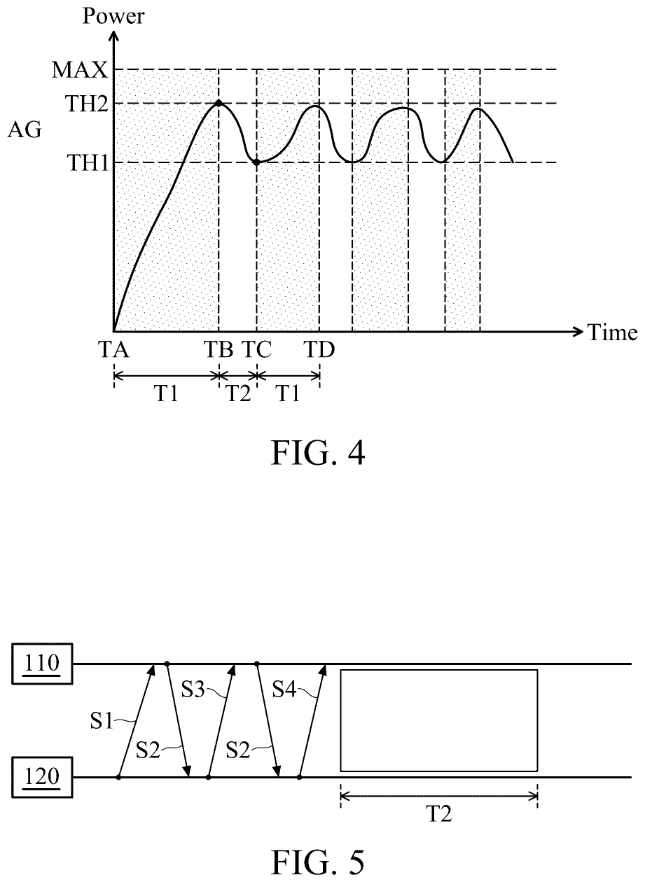

FIG. 4 is a diagram of the waveform of the timing average AG of the power of the RF signal SF according to an embodiment of the invention. Please refer to FIG. 1 and FIG. 4 together. In the embodiment of FIG. 4, the control circuit 150 can analyze the power of the RF signal SF, and control the transmitter module 130 according to the power of the RF signal SF. Specifically, the control circuit 150 can calculate a timing average AG of the power of the RF signal SF. The timing average AG may mean a moving-average value of the power of the RF signal SF over a period of time (such as 30 seconds in the past), and such a moving-average value may be continuously updated as time goes by. In some embodiments, the timing average AG can be calculated according to the following equation (1), but it is not limited thereto.

$$\frac{1}{T} {\int }_{0}^{T} P ( t ) \cdot dt \qquad ( 1 )$$

where “T” represents a period of time, “P(t)” represents the time function of the (instantaneous) power of the RF signal SF, and “t” represents a time parameter.

Then, the control circuit 150 can compare the timing average AG with a first threshold TH1 and a second threshold TH2. The first threshold TH1 and the second threshold TH2 may be previously stored in the control circuit 150, and they are adjustable according to different requirements. The second threshold TH2 is higher than the first threshold TH1. In some embodiments, the first threshold TH1 is considered as a lower threshold, and the second threshold TH2 is considered as a higher threshold. Both the first threshold TH1 and the second threshold TH2 are lower than a maximum threshold MAX. For example, the maximum threshold MAX may correspond to the maximum power of the RF signal SF, the first threshold TH1 may be from 50% to 70% of the maximum threshold MAX, and the second threshold TH2 may be from 80% to 95% of the maximum threshold MAX, but they are not limited thereto.

As shown in FIG. 4, at a first time point TA, the timing average AG starts to gradually rise up. Next, at a second time point TB, if the timing average AG increases and reaches the second threshold TH2, the control circuit 150 can control the transmitter module 140 to stop an uplink transmission (i.e., to stop transmitting the RF signal SF to the network device 110). The time interval between the first time point TA and the second time point TB may be considered as a first time period T1, during which the RF signal SF is transmitted and the uplink transmission is performed. After the second time point TB, the timing average AG starts to gradually drop down. At a third time point TC, if the timing average AG decreases and reaches the first threshold TH1, the control circuit 150 can control the transmitter module 130 to resume the uplink transmission (i.e., to resume transmitting the RF signal SF to the network device 110). The time interval between the second time point TB and the third time point TC may be considered as a second time period T2, during which the transmission of the RF signal SF (i.e., the uplink transmission) is stopped. After the third time point TC, the timing average AG starts to gradually rise up again. Then, at a fourth time point TD, if the timing average AG increases and reaches the second threshold TH2, the control circuit 150 can control the transmitter module 140 to stop the uplink transmission (i.e., to stop transmitting the RF signal SF to the network device 110) again. The time interval between the third time point TC and the fourth time point TD may be considered as another first time period T1, during which the RF signal SF is transmitted and the uplink transmission is performed. As a result, the first time periods T1 and the second time periods T2 can be clearly defined by the control circuit 150 according to the fluctuation of the timing average AG between the first threshold TH1 and the second threshold TH2.

FIG. 5 is a diagram of signal transmission between the network device 110 and the communication device 120 according to an embodiment of the invention. It should be understood that the operations of the communication device 120 can be performed by the transmitter module 130 and the control circuit 150 therein. Initially, communication device 120 transmits an RF signal including an uplink request S1 to the network device 110. In response, the network device 110 transmits an uplink grant S2 back to the communication device 120, thereby allocating the uplink resource. Then, the communication device 120 can determine whether to perform an uplink transmission or not. In some embodiments, the communication device 120 transmits the RF signal including a first request S3. The first request S3 provides a BSR (Buffer Status Report) which is not equal to 0 (BSR≠0), and it indicates that the communication device 120 is going to transmit some data to the network device 110. In alternative embodiments, the communication device 120 transmits the RF signal including a second request S4. The second request S4 provides another BSR which is equal to 0(BSR=0), and it indicates no data is going to be transmitted from the communication device 120 to the network device 110. If the network device 110 receives the second request S4, it can get the information that the communication device 120 prepares a following second time period T2. During the second time period T2, the communication device 120 can stop transmitting any RF signal SF to the network device 110 (i.e., stop any uplink transmission to the network device 110), so as to reduce the timing average AG of the power of the RF signal SF. In some embodiments, the control circuit 150 of the communication device 120 can analyze the uplink grant S2 from the network device 110, and estimate whether the timing average AG of the power of the RF signal SF is close to the first threshold TH1 or the second threshold TH2 according to the information of the uplink grant S2.

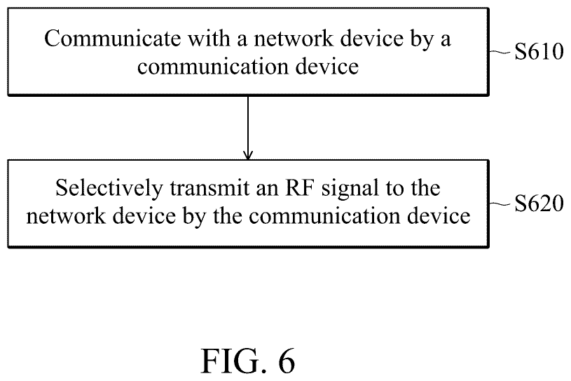

FIG. 6 is a flowchart of a communication method according to an embodiment of the invention. To begin, in step S610, a network device is communicated with by a communication device. Next, in step S620, an RF signal is selectively transmitted to the network device by the communication device. It should be understood that these steps are not required to be performed in order, and every feature of the embodiments of FIGS. 1 to 5 may be applied to the communication method of FIG. 6.

The invention proposes a communication system, a communication device, and a communication method. In comparison to the conventional design, the invention has at least the advantages of satisfying the SAR requirements and decreasing the overall power consumption. Therefore, the invention is suitable for application in a variety of systems and devices.

Note that the above element parameters are not limitations of the invention. A designer can fine-tune these settings or values to meet different requirements. It should be understood that the communication system, the communication device, and the communication method of the invention are not limited to the configurations of FIGS. 1-6. The invention may merely include any one or more features of any one or more embodiments of FIGS. 1-6. In other words, not all of the features displayed in the figures should be implemented in the communication system, the communication device, and the communication method of the invention.

The method of the invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application-specific logic circuits.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A communication device for communicating with a network device, comprising:
a transmitter module; and
a control circuit, controlling the transmitter module to selectively transmit an RF signal to the network device.

2. The communication device as claimed in claim 1, wherein the transmitter module transmits the RF signal to the network device during a plurality of first time periods.

3. The communication device as claimed in claim 2, wherein the transmitter module stops transmitting the RF signal to the network device during a plurality of second time periods.

4. The communication device as claimed in claim 3, wherein the second time periods are interleaved with the first time periods.

5. The communication device as claimed in claim 3, wherein power of the RF signal is set to 0 during the second time periods.

6. The communication device as claimed in claim 1, wherein the control circuit controls the transmitter module according to power of the RF signal.

7. The communication device as claimed in claim 6, wherein the control circuit calculates a timing average of the power of the RF signal, and compares the timing average with a first threshold and a second threshold.

8. The communication device as claimed in claim 7, wherein the second threshold is higher than the first threshold.

9. The communication device as claimed in claim 7, wherein if the timing average increases and reaches the second threshold, the control circuit controls the transmitter module to stop an uplink transmission.

10. The communication device as claimed in claim 9, wherein if the timing average decreases and reaches the first threshold, the control circuit controls the transmitter module to resume the uplink transmission.

11. A communication method, comprising the steps of:
communicating with a network device by a communication device; and
selectively transmitting an RF signal to the network device by the communication device.

12. The communication method as claimed in claim 11, further comprising:
transmitting the RF signal to the network device by the communication device during a plurality of first time periods.

13. The communication method as claimed in claim 12, further comprising:
stopping transmitting the RF signal to the network device by the communication device during a plurality of second time periods.

14. The communication method as claimed in claim 13, wherein the second time periods are interleaved with the first time periods.

15. The communication method as claimed in claim 11, further comprising:
forcing power of the RF signal to be 0 by the communication device during the second time periods.

16. The communication method as claimed in claim 11, further comprising:
calculating a timing average of power of the RF signal by the communication device; and
comparing the timing average with a first threshold and a second threshold by the communication device.

17. The communication method as claimed in claim 16, wherein the second threshold is higher than the first threshold.

18. The communication method as claimed in claim 16, further comprising:
if the timing average increases and reaches the second threshold, stopping an uplink transmission by the communication device.

19. The communication system as claimed in claim 18, further comprising:
if the timing average decreases and reaches the first threshold, resuming the uplink transmission by the communication device.

20. A network device for communicating with a communication device, comprising:
a transmitter module; and
a control circuit, controlling the transmitter module to receive an RF signal from the communication device.
